(19) United States
(12) Patent Application Publication
(10) Pub. No.: US 2010/0072343 A1
(43) Pub. Date: Mar. 25, 2010

(54) Multiple-compartmented platform capable of holding dispensers and interchangeable towel holders

(76) Inventors: André Lydell Glover, (US); James Henry Johnson, JR., (US)

Correspondence Address: Andre' L. Glover, 5269 Lodestone Loop, Memphis, TN, 38109, US

(21) Appl. No.: 12/586,490

(22) Filed: Sep. 23, 2009

Related U.S. Application Data
(60) Provisional application No. 61/192,826, filed on Sep. 23, 2008.

(51) Int. Cl. F16M 13/00; B65H 16/04; F16M 13/06; A47K 10/12; A47K 10/22

(52) U.S. Cl. 248/558; 248/346.01; 242/597.7

(57) ABSTRACT

A base (10) with multiple compartments has a hole (22) at its center. The base is made of a sturdy material. The hole accepts a rod (32) which supports a roll of towels (36). The hole also accepts an attachment (48). The compartments are capable of holding common household dispensers. A groove (24) accepts a cover (38).

### CROSS-REFERENCE TO RELATED APPLICATIONS

This application claims the benefit of PPA Ser. No. 61/192,826, filed 2008 Sep. 23 by the present inventors.

### FEDERALLY SPONSORED RESEARCH

Not Applicable

### SEQUENCE LISTING OF PROGRAM

Not Applicable

### BACKGROUND OF THE INVENTION—FIELD OF THE INVENTION

This invention relates to the methods by which people bring together items necessary for cleaning, drying, and moisturizing body parts.

### BACKGROUND OF THE INVENTION

Many people wash and dry their hands multiple times each day. These tasks usually involve moving to one area for the soap, another to wash, and even another to dry. For a number of these people, their hands begin to dry out too much, causing discomfort, so they look for something to moisturize with. There is an inherent inconvenience in not having soap, a way to dry off, and some form of moisturizer within arm's reach.

There are currently known devices for dispensing cleaning fluids and wipers such as paper towels for use in cleaning. An example of such is disclosed in U.S. Pat. No. 4,436,224 to McInerny (1984). In such devices the fluid is held in a dispenser which has an elongated neck attached to a base member, all of which forms the fluid chamber. A roll of wipers such as paper towels is placed on the elongated neck and rests on the base. A fluid dispensing fixture is then attached to the top of the outlet aperture, or to the side of the bottom, depending on which modification is used.

As a result of the location of the placement of where the fluid exits the device from the top, the towels may become to become soiled. Furthermore, when refilling this device it is possible to spill fluid on the towels if they are on the device when it is refilled. If the towels are not present, spillage could still occur on the unit itself, or whatever surface the unit is placed on. There may also be spills on the surface directly below where the bottom mounted spigot is located. The stability of the device may come into question once both the towel and fluid level become low. Trying to remove a towel could require the user to hold the unit to prevent it from sliding or tipping. The device also allows only one type of fluid to be dispensed at a time.

Another example of the art is that disclosed in U.S. Pat. No. 5,819,989 to Saraceni (1998). In this case a spray dispenser is illustrated. The device again illustrates an elongated neck which is hollow and capable of holding fluid. This device appears to be more conducive to dispensing less viscous cleaning fluids. The effort required to move liquid soap through the aperture would be appear to be difficult, if possible. Nevertheless, the dispensing devices and towel holders heretofore known suffer from a number of disadvantages:

(a) A dispenser currently used by a consumer is not compatible with the available products offered by the prior art. The consumer's own dispenser must have its contents emptied into a prior art dispenser. Their emptied dispenser is then saved, recycled, or maybe even thrown away.

(b) They are limited to the dispensing of only one fluid at a time. To dispense any other fluid, the user must have multiple copies of the prior art or have separate fluid dispensing devices available.

(c) The capacity of the dispensers requires a significant amount of fluid to fill from empty.

(d) In order to utilize the contents of the fluid dispenser, most likely the entire unit must be taken to the location where it is needed. It is unconventional to take only a handful of fluid to a different location.

(e) They limit the type of towels that can be used with the device. Most are only offered for use with roll-type towels.

(f) Once a towel has been removed it cannot be placed back onto the unit for reuse.

(g) The towels are oriented in limited configurations. In order to use the towels in a different position, the entire unit must have its orientation changed.

(h) There are minimal spaces for the storage of anything else.

### BACKGROUND OF THE INVENTION—OBJECTS AND ADVANTAGES

Accordingly, several objects and advantages of our invention are:

(a) to provide a device capable of holding dispensers that are in everyday use by consumers;

(b) to provide a device capable of allowing consumers to use multiple dispensers simultaneously;

(c) to provide a device that allows consumers to use dispensers that hold a more manageable amount of fluid;

(d) to provide a device which allows consumers to remove dispensers, take and use them in a different location, and then return them without having had to carry the entire device;

(e) to provide a device allowing the use of both roll-type and non-roll-type towels;

(f) to provide a device allowing the use of reusable towels;

(g) to provide a device capable of allowing the use of towels in multiple positions to facilitate ease of retrieval;

(h) to provide locations to store other items.

Further objects and advantages are to provide a device that allows dispensers to be situated in a location on a surface that would not allow for dripping onto the towels. These dispensers are some of those sold by makers and marketers of liquid soap and moisturizers, which are more than likely currently in the home already. Also, in one modification of our invention, there is a cover for the towels that allows the user to reach through an opening and dispense the towels without removing the cover. In another, a roll of towels can be placed in a horizontal position for an under-the-counter type dispensing. And in one other modification, there is a way to utilize a cloth-type towel. In addition, there are multiple other locations on our device for storage. Our invention brings together several typical household items to a useful and convenient location. Further objects and advantages of our invention will become apparent from a consideration of the drawings and ensuing description.

### SUMMARY

In accordance with the present invention a platform comprises a multi-compartmented base having interchangeable towel holders and a cover which attach to it.

### DRAWINGS—FIGURES

In the drawings, closely related figures have the same number but different alphabetic suffixes.

FIG. 1 shows a frontal view of a base with a cover installed.

FIG. 2 shows an exploded view of a base with a cover.

FIG. 3 shows a frontal view of a base with an accessory towel holder installed.

FIG. 4 shows an exploded view of a base with an accessory towel holder.

FIG. 5 shows a frontal view of a base with an accessory towel holder installed.

FIG. 6 shows an exploded view of a base with an accessory towel holder.

FIG. 7 shows an exploded view of a base with an accessory plug.

FIG. 8 shows a top view of a base.

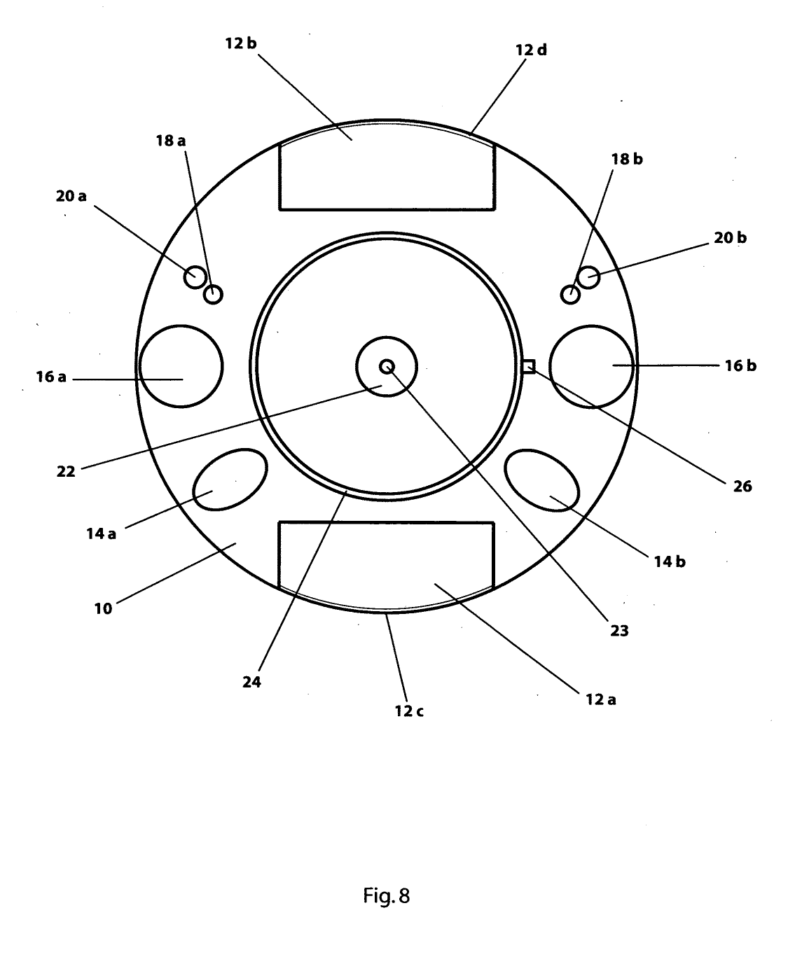

### DRAWINGS—REFERENCE NUMERALS

| | |
|---|---|
| 10 | base |
| 12a | shelf |
| 12b | shelf |
| 12c | shelf lip |
| 12d | shelf lip |
| 14a | compartment |
| 14b | compartment |
| 16a | compartment |
| 16b | compartment |
| 18a | compartment |
| 18b | compartment |
| 20a | compartment |
| 20b | compartment |
| 22 | rod guide hole |
| 23 | hole |
| 24 | cover groove |
| 26 | cover toe slot |
| 28 | screw |
| 30 | washer |
| 31 | plug |
| 32 | rod |
| 33 | threaded hole |
| 34a | threaded hole |
| 34b | threaded hole |
| 36 | roll of towels |
| 38 | cover |
| 40 | cover toe |
| 42 | cover slit |
| 44 | cover hand opening |
| 46 | cover lobe |
| 48 | goal post attachment |
| 50 | threaded hole |
| 52a | towel holder notch |
| 52b | towel holder notch |
| 54 | towel holder |
| 56a | flange |
| 56b | flange |
| 58 | spring |
| 60 | towel |
| 62 | ring |
| 64 | screw stud |
| 65 | screw mounting hole |
| 66 | spherical lobe |
| 68 | ring hole |

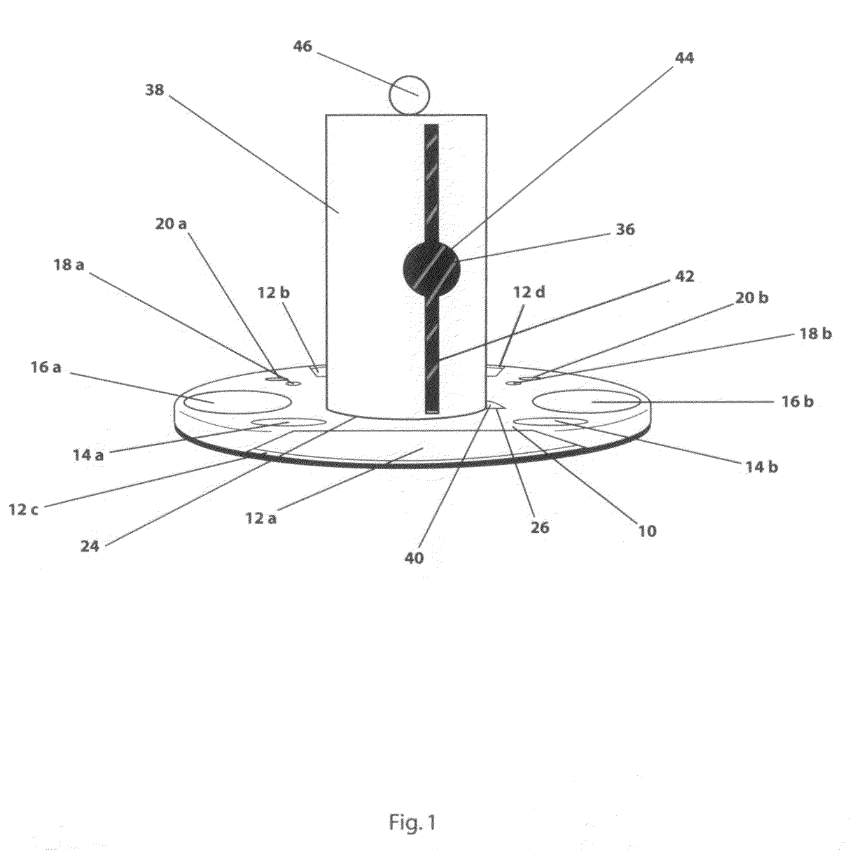

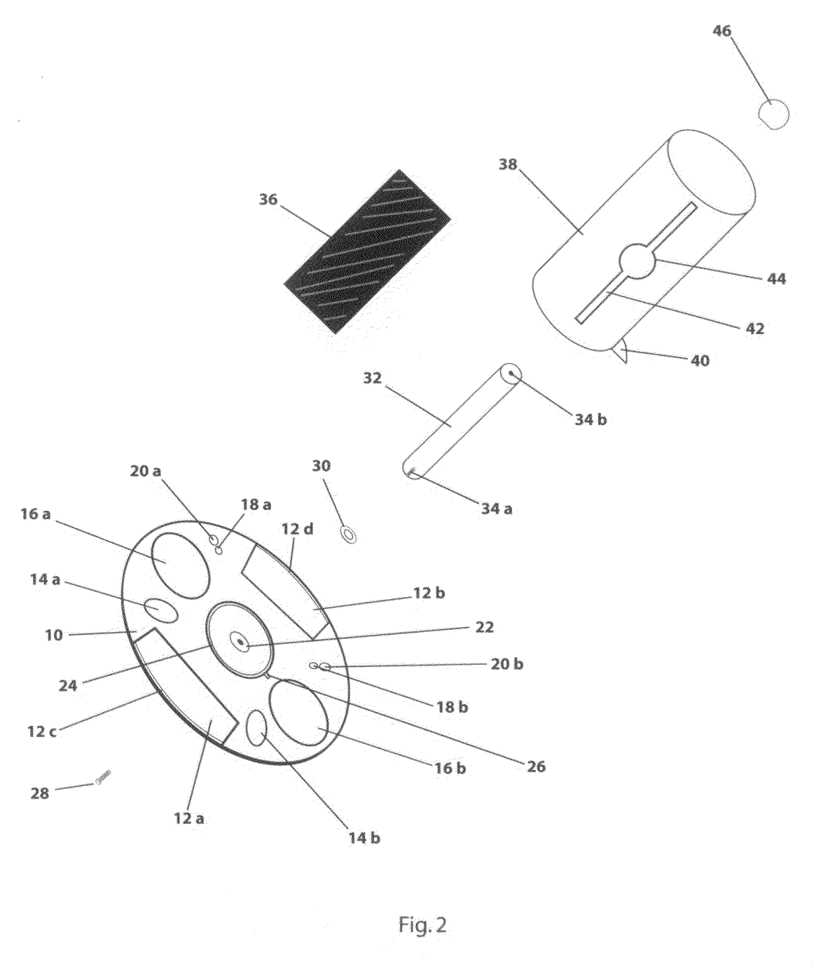

### DETAILED DESCRIPTION—FIGS. 1 AND 2-PREFERRED EMBODIMENT

A preferred embodiment of the present invention is illustrated in FIG. 1 and FIG. 2. The platform consists of a base 10 of moderate thickness. A hole 23 begins at the center of the bottom of base 10 and terminates at a rod guide hole 22. A screw 28 is able to pass through hole 23. Rod guide hole 22 is surrounded by a cover groove 24. A cover toe slot 26 is directly adjacent to cover groove 24. A shelf 12a is in front of cover groove 24. A shelf lip 12c is found at the leading edge of shelf 12a. A shelf 12b is behind cover groove 24. A shelf lip 12d is found at the leading edge of shelf 12b. A compartment 14a is behind, and to the left of shelf 12a. A compartment 16a is behind compartment 14a. A compartment 18a is behind compartment 16a. A compartment 20a is adjacent to compartment 18a, separated by a small distance. A compartment 14b is behind, and to the right of shelf 12a. A compartment 16b is behind compartment 14b. A compartment 18b is behind compartment 16b. A compartment 20b is adjacent to compartment 18b, separated by a small distance.

A washer 30 fits into rod guide hole 22. A rod 32 has at its lower end a threaded hole 34a and at its upper end a threaded hole 34b. A roll of towels 36 fits over rod 32. A cover 38 comprises a cover toe 40 at its lower end, a cover slit 42 running along a majority of its height, a cover hand opening 44 at approximately the mid point of the cover slit, and a cover lobe 46 at its top.

The base, the rod, and the cover in the preferred embodiment are wooden. However, these components can be made from other long lasting and sturdy materials, such as aluminum, stainless steel, ceramic, gold, plastic, and rubber. The base is typically 33.02 cm in diameter and 5.08 cm in thickness. The diameters of the compartments vary, but they are typically 4.445 cm in depth. The rod has atypical length of 32.385 cm.

### Operation—FIGS. 1 and 2

Screw 28 is threaded through hole 23. Washer 30 is placed into rod guide hole 22. Rod 32 is place into rod guide hole 22 with threaded hole 34a screwed onto screw 28. Roll of towels 36 is then placed over rod 32 until is rests on base 10 and the first towel is facing frontward. While holding cover lobe 46, cover 38 is then placed on the base by placing its bottom portion in cover groove 24 so that cover toe 40 rests in cover toe slot 26. A hand is then placed through cover hand opening 44 to retrieve the lead towel. The lead towel is passed through cover slit 42. Dispensers and any other items can now be placed in the appropriate compartments. The system is now ready for use.

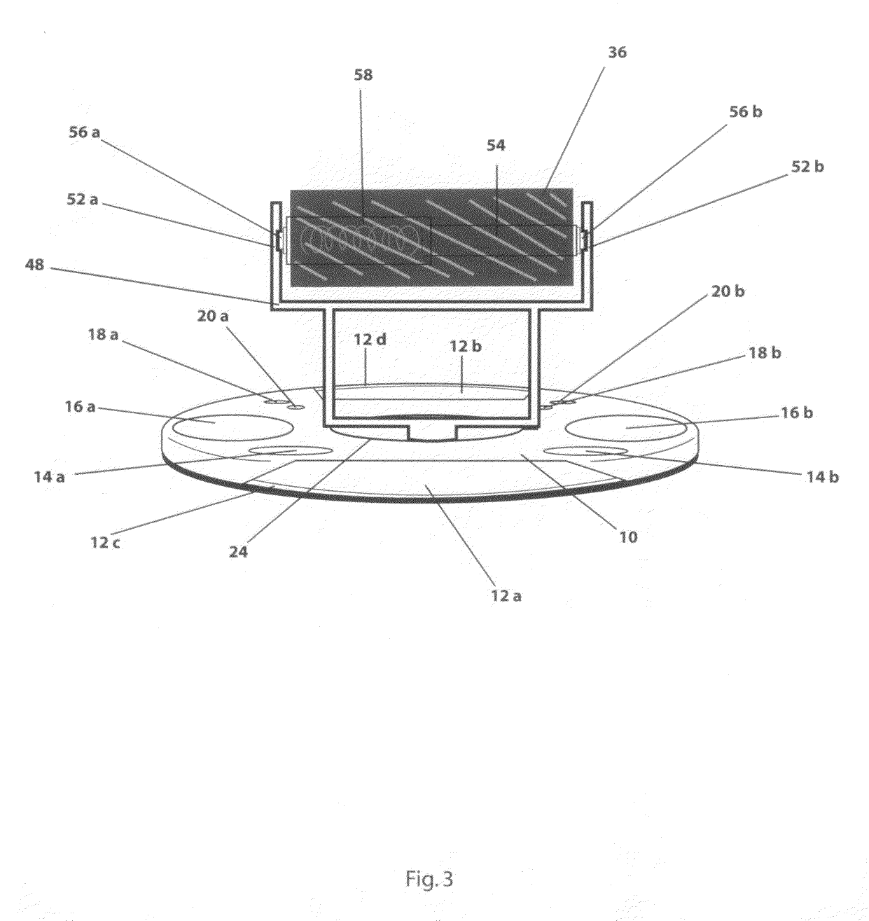

### FIGS. 3-7—Additional Embodiments

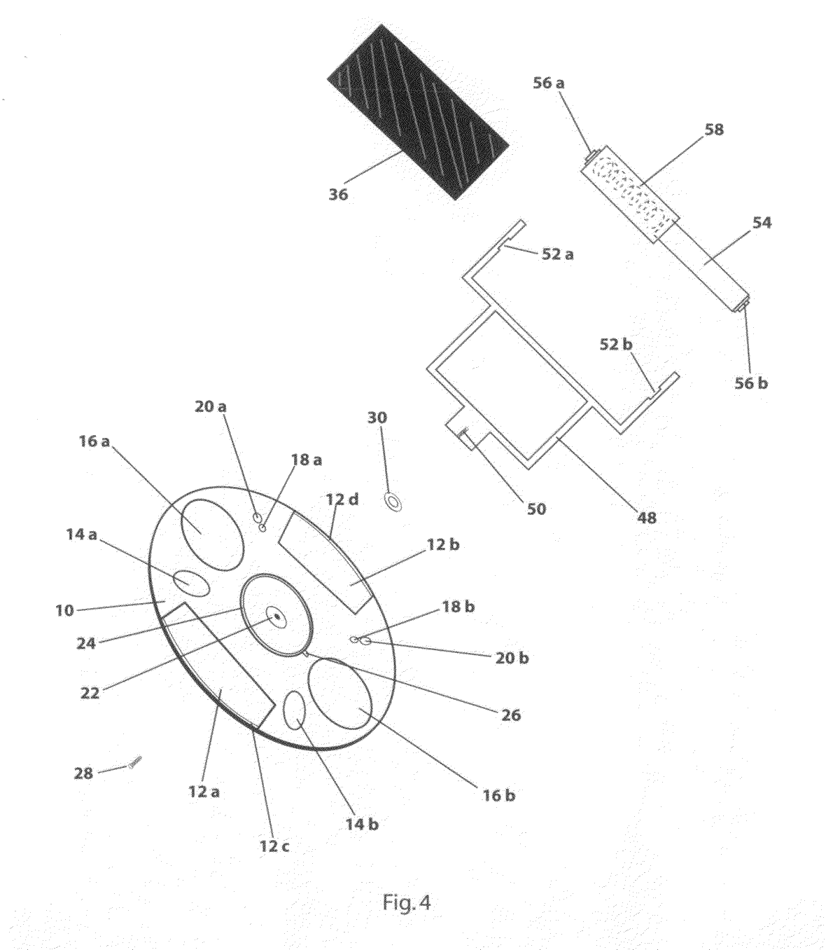

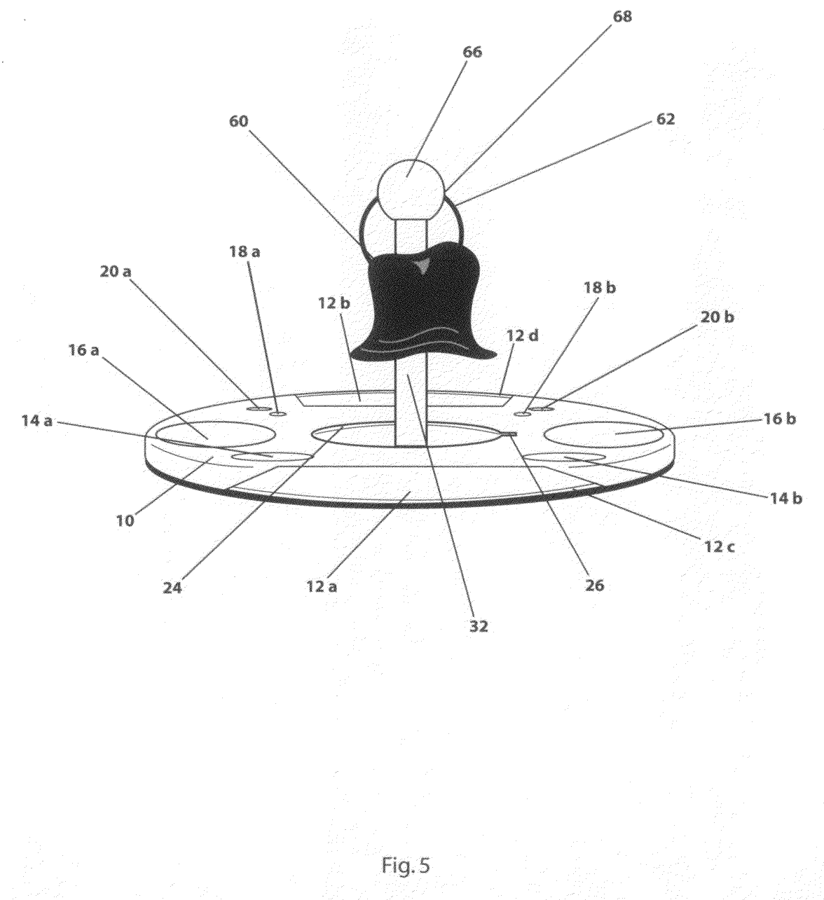

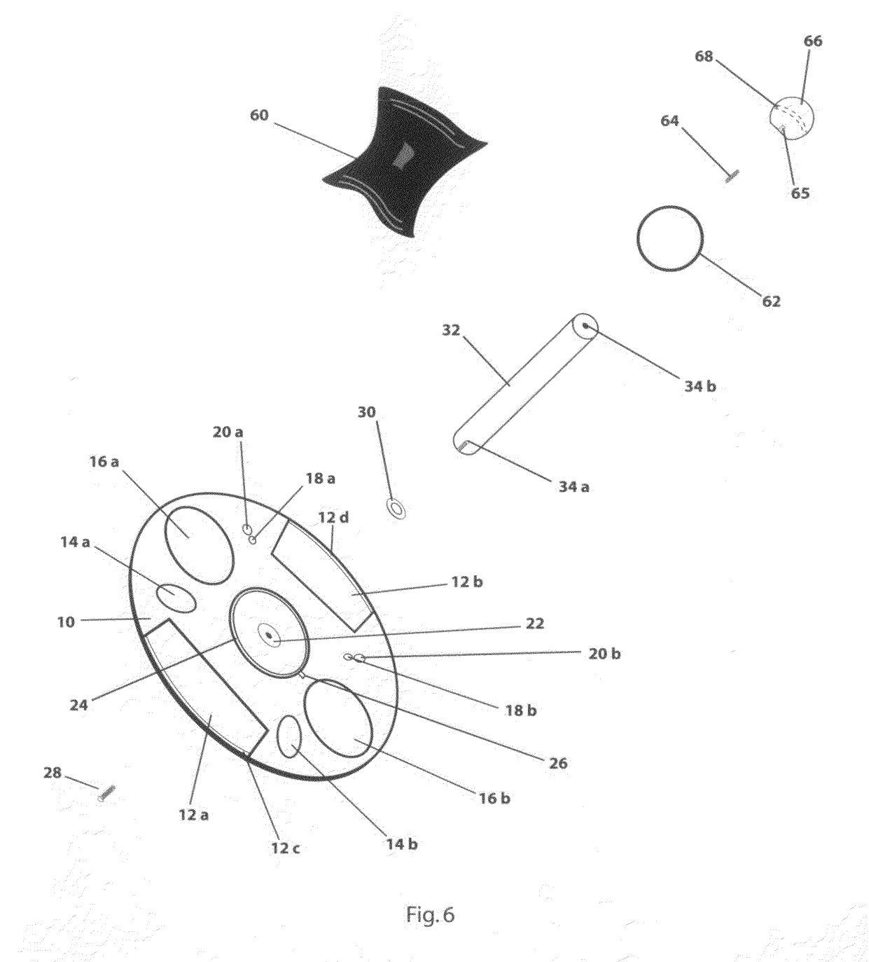

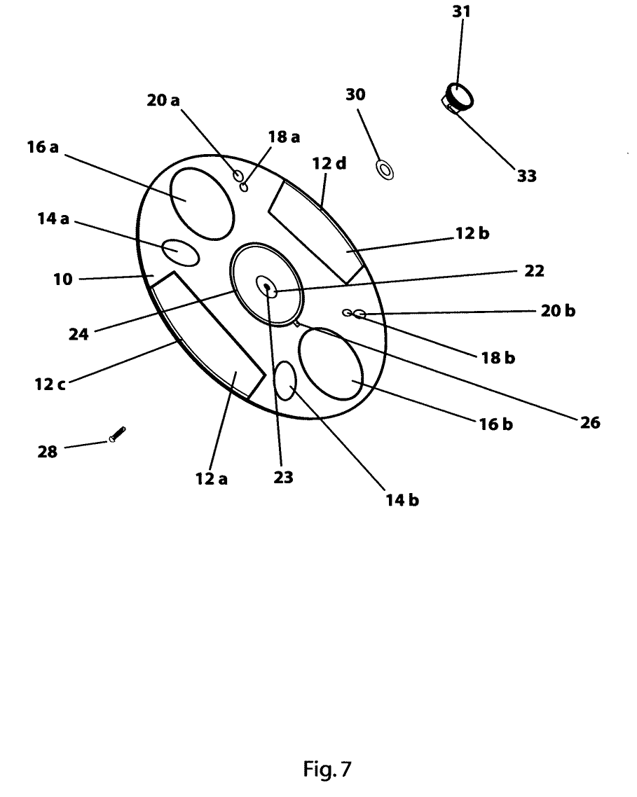

Additional embodiments are shown in FIGS. 3, 4, 5, 6, and 7. In FIGS. 3 and 4, a goal post attachment 48 is added. The goal post attachment is attached to the base via a threaded hole 50 on its bottom portion being placed into rod guide hole 22 and screwed onto screw 28. A roll of towels is placed onto a towel holder 54. Towel holder 54 has a spring 58 inside of it. The towel holder also has a flange 56a at one end, and a flange 56b at the other end. These flanges are seated in a towel holder notch 52a at one side, and a towel holder notch 52b at the opposite side of the goal post attachment. Dispensers can now be placed in the appropriate compartments and the towels are ready for use. In FIGS. 5 and 6, a ring 62 accessory is added. The ring is one that can be snapped together. It is unsnapped and then fed through a ring hole 68 in a spherical lobe 66 and snapped back together so as to be a continuous ring again. Spherical lobe 66 comprising a lobe hole 68, a screw stud 64 mounted into a screw mounting hole 65, is screwed into threaded hole 34b on rod 32. This rod can now be mounted to the base. A towel 60, can be draped over the ring. In FIG. 7, a plug 31 is added. The plug has a threaded hole 33 that is secured to screw 28 coming up through rod guide hole 22.

### Advantages

From the description above, a number of advantages of our multi-compartmented platform and interchangeable towel holders become evident:

(a) Many types of individual fluid dispensers currently in use by households today are compatible with our invention, thus allowing the consumer to forgo purchasing a new dispenser.

(b) The end user now has the option of having the use of multiple dispensers at once.

(c) Consumers can now use smaller, more convenient dispensers.

(d) The containers of fluid can be removed and returned individually, without having to handle the entire unit.

(e) Both roll and non-roll-type towels can be used, depending on the preference of the user.

(f) Regular household towels will be compatible with the towel holder.

(g) Towels can be placed in a vertical or horizontal position without affecting their ability to be dispensed or inhibiting the ability of any dispensers placed in the base.

(h) The platform offers multiple locations capable of storing other items.

### CONCLUSION, RAMIFICATIONS, AND SCOPE

Accordingly, the reader will see that the multi-compartmented platform with interchangeable towel holders can facilitate different types of towels in different orientations, accommodate many of the fluid dispensers sold at retail outlets today, and provide the consumer with multiple storage locations for other things like keys, pens, pencils, wallets, and cellular phones. In addition the platform takes up roughly the space of a common household plate. Furthermore, the platform and its interchangeable towel holders has additional advantages in that
it does not require the purchase of any new specialized fluid dispenser;
it allows for the storage and use of multiple dispensers;
it allows the dispensers to be removed and returned without having to move the entire unit;
it permits the use of different types of towels;
it permits towels to be dispensed in different orientations;
it allows for additional storage of items.

Although the description above contains many specificities, these should not be construed as limiting the scope of the invention but as merely providing illustrations of some of the presently preferred embodiments of this invention. For example, the base can have other shapes, such as triangular, rectangular, hexagonal, oval, trapezoidal, octagonal, and pentagonal, among others; the base can also operate on a carousel system; the cover can have other shapes, such as triangular, rectangular, hexagonal, oval, among others; the rod can have other shapes, such as triangular, rectangular, hexagonal, oval, trapezoidal, among others; the rod could connect to the base via a latch, a weld, magnetism, and other ways; the compartments can have other shapes, such as rectangular, trapezoidal, triangular, among others.

Thus the scope of the invention should be determined by the appended claims and their legal equivalents, rather than by the examples given.

We claim:

1. A. base comprising a plurality of compartments.

2. The base of claim 1 wherein said compartments have varied shapes.

3. The base of claim 1 wherein said compartments have varied depths.

4. The base of claim 1 wherein a hole is positioned at its center.

5. The hole of claim 4 wherein a rod is accepted into said hole.

6. The rod of claim 5 wherein a threaded hole is found at either end.

7. The rod of claim 5 wherein the rod accepts a hollow core with towels wrapped around it.

8. The base of claim 1 wherein a groove is located a determined radius around its center.

9. The groove of claim 8 wherein a cover rests in it.

10. The cover of claim 9 wherein a slit runs along its vertical axis.

11. The cover of claim 9 wherein a circular opening intersects the slit.

12. A base comprising a plurality of compartments and a hole at the center.

13. The hole of claim 12 accepts an accessory.

14. The accessory accepts a paper holder.

15. The hole of claim 12 accepts a rod with a threaded hole at either end.

16. The rod of claim 15 accepts a lobe.

17. The lobe of claim 16 accepts a ring.

18. The ring of claim 17 holds a towel.

19. The hole of claim 15 accepts a plug.
